(19) United States
(12) Patent Application Publication
(10) Pub. No.: US 2021/0065109 A1
(43) Pub. Date: Mar. 4, 2021

(54) SYSTEMS AND METHODS FOR SELF-RETURNS

(71) Applicant: Walmart Apollo, LLC, Bentonville, AR (US)

(72) Inventors: Michael L. Payne, Centerton, AR (US); Grace K. Shea, San Francisco, CA (US); Prashanth Allamaraju, Bentonville, AR (US); Saheli R. Chowdhury, Bentonville, AR (US); Tanvi Chopra, San Francisco, CA (US)

(21) Appl. No.: 16/999,501

(22) Filed: Aug. 21, 2020

Related U.S. Application Data
(60) Provisional application No. 62/892,950, filed on Aug. 28, 2019.

(51) Int. Cl. G06Q 10/08; G06Q 20/40; G06Q 20/20; G06Q 20/18; G06N 5/02

(52) U.S. Cl. CPC G06Q 10/0837; G06Q 20/4014; G06N 5/025; G06Q 20/209; G06Q 20/18; G06Q 20/208

(57) ABSTRACT

In some embodiments, apparatuses and methods are provided herein useful to self-returns. In some embodiments, a system for self-returns in a retail facility comprises a kiosk comprising a user input device, a display device, and a printer configured to print labels, a control circuit configured to receive the order identifier, receive based on the order identifier, transaction information, transmit, for presentation, the transaction information, receive selection of an item from the transaction, determine, based on eligibility rules, that the item is eligible for return via the kiosk, generate a label associated with a return of the item, transmit, for printing, the label, and create, in a the database, a return transaction, and an associate device configured to scan the label, and transmit an indication of the label and an indication that the item was received, wherein the control circuit is further configured to finalize the return transaction for the item.

### CROSS-REFERENCE TO RELATED APPLICATION

This application claims the benefit of U.S. Provisional Application Number 62/892,950, filed Aug. 28, 2019, which is incorporated by reference in its entirety herein.

### TECHNICAL FIELD

This invention relates generally to retail shopping and, more particularly, self-service retail shopping.

### BACKGROUND

As technology advances and becomes more affordable, some retail facilities have employed self-checkout stations. Typically, these self-checkout stations are offered as an option to customers. Unlike traditional point-of-sale (POS) terminals in which an employee of the retail facility scans items and facilitates the sale of the items, self-checkout stations allow the customer to perform these actions. That is, self-checkout stations typically function like traditional POS terminals but are operated by the customer. The customer scans his or her items, bags his or her items (if necessary), and provides payment for the transaction. Some customers prefer self-checkout stations as they believe them to be faster and/or more convenient than typical employee-operated POS terminals. Even with the advances in technology and the benefits of shelf-checkout stations, retail facilities have not adopted a similar model for returns. Rather, if a customer wishes to return an item, he or she must do so at a POS terminal that is operated by an employee of the retail facility. Because of this, the benefits of self-checkout stations have not been carried over on the returns side. Consequently, a need exists for systems, methods, and apparatuses that allow self-return by customers.

### BRIEF DESCRIPTION OF THE DRAWINGS

Disclosed herein are embodiments of systems, apparatuses and methods pertaining to self-returns. This description includes drawings, wherein:

FIG. 1A depicts a customer 110 returning an item 114 at a kiosk 102 for self-service returns, according to some embodiments;

FIG. 1B depicts an employee 116 scanning the item 114 in a self-return system, according to some embodiments;

FIG. 2 is a block diagram of a system 200 for self-returns, according to some embodiments; and

FIG. 3 is a flow chart depicting example operations for a self-return system, according to some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein useful to self-returns in a retail facility. In some embodiments, a system for self-returns in a retail facility comprises a kiosk, the kiosk comprising a user input device, wherein the user input device is configured to accept input from a user, wherein the user input includes an order identifier, a display device, wherein the display device is configured to present transaction information to the user, wherein the transaction information includes items associated with a transaction, and a printer, wherein the printer is configured to print labels, a control circuit, wherein the control circuit is communicatively coupled to the database and the kiosk, wherein the control circuit is configured to receive, from the kiosk, the order identifier, receive, from the database based on the order identifier, transaction information associated with the order identifier, transmit, to the kiosk for presentation on the display device, the transaction information associated with the order identifier, receive, from the user input device of the kiosk, selection of one or more of the items associated with the transaction, determine, based on eligibility rules, that at least one of the one or more items are eligible for return via the kiosk, generate, for the at least one of the one or more items, a label, wherein the label is associated with a return of the at least one of the one or more items, transmit, to the kiosk for printing, the label, wherein the label is configured to be secured to the at least one of the one or more items, and create, in a the database, a return transaction for the at least one of the one or more items, and an associate device, wherein the associate device is communicatively coupled to the control circuit and the database, the associate device configured to scan, via an associate device scanner, the label, and transmit, to the database, an indication of the label and an indication that the at least one of the one or more items was received, wherein the control circuit is further configured to finalize, based on inclusion of the indication of the label and the indication that the at least one of the one or more items was received, the return transaction for the at least one of the one or more items.

As previously discussed, many retail facilities have adopted self-checkout stations. These self-checkout stations can provide advantages to customers in that a retail facility can operate a greater number of self-checkout stations than employee-operated POS terminals resulting in shorter wait times and convenience for the customer. Additionally, self-checkout stations benefit retail facilities in that they need not be individually staffed. Rather, a group of self-checkout stations (e.g., four self-checkout stations) can be monitored by a single employee. The single employee provides assistance when necessary. Because a single employee can monitor multiple self-checkout stations, a retail facility can operate a greater number of POS terminals and complete sales with fewer employees tasked to POS terminals.

Unfortunately, though there are many benefits to self-checkout stations, this technology has not been adopted for the returns side. Rather, a customer typically must make a return at a customer service desk or other POS terminal that is operated by an employee. One of the reasons for this is that returns present different problems than purchases. For example, when an item is returned, the condition of the item must be verified, the presence of the item must be verified, return restrictions must be considered, etc. Because of the difficulties arising from returns, self-return options for customers are limited.

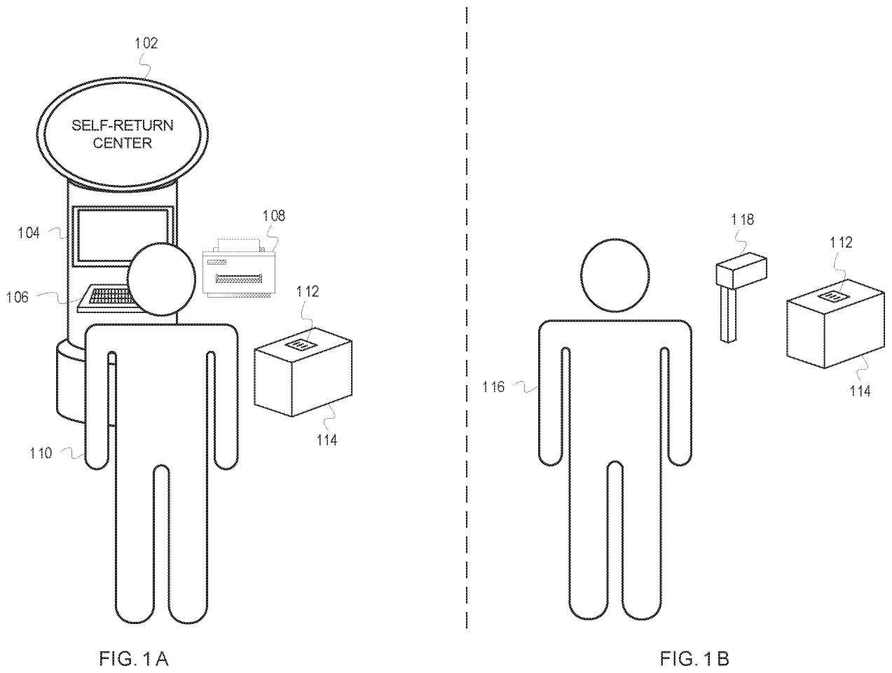

Disclosed herein are system, methods, and apparatuses that seek to eliminate, or at least minimize, some of these problems so as to allow self-returns by customers. In one embodiment, a system includes a self-return terminal (generally referred to as a “kiosk”). A customer can use the self-return kiosk much like a self-checkout station. That is, the customer operates the self-return kiosk with little or no assistance from an employee of the retail facility. When a customer returns an item, a label is created. The customer secures the label to the item, or packaging for the item, to be returned and deposits the item (e.g., in a designated bin, in a specified area, with an employee, etc.). At this point, the customer is able to leave the retail facility. At some later time, an associate of the retail facility aids in processing the returns by scanning the labels. When the labels are scanned, it indicates that the returned item was properly received, and the return transaction can be finalized. The discussion of FIG. 1 provides and overview of a self-return system.

FIG. 1A depicts a customer 110 returning an item 114 at a kiosk 102 for self-service returns, according to some embodiments. In FIG. 1A, the customer 110 is interacting with the kiosk 102 (i.e., a “self-return” kiosk) to return an item 114. Though this discussion refers to a “kiosk” for ease of reading, the term “kiosk” is used generally to refer to any terminal or station at which a customer cab return items (i.e., the “kiosk” can be a POS terminal, a station with a computing device such as a tablet computer, a service desk, etc.). The kiosk 102 includes a display device 104, a user input device 106, and a printer 108. The customer 110 interacts with the kiosk 102 much like he or she would with a self-checkout system. That is, the customer 110 enters information via the user input device 106 and information relating to the transaction is presented to the customer 110 via the display device 104.

As one example, the user input device 106 can include a touchscreen and a scanner. The customer 110 uses the scanner to scan a receipt (e.g., a receipt printed at the time of purchase, an invoice, an order history, etc. including an order identifier). The display device 104, in this case, the touchscreen, presents transaction information associated with the order identifier. For example, the display device 104 can present a list of items included in the transaction, pricing information for the items purchased, return eligibility, return fees, etc. The customer 110 selects, from the transaction information, the item that he or she would like to return. Alternatively, the customer 110 can scan the item 114 (e.g., a SKU or other item identifier associated with the item) to indicate that he or she would like to return the item 114.

Assuming the item 114 is eligible for return, a return transaction for the item 114 is generated and the printer 108 prints a label 112. The label 112 is associated with the return transaction and includes a unique identifier. The unique identifier can identify the item 114, the order identifier, the customer 110, etc. as required to aid in return of the item 114. The unique identifier can be optical and/or electrical. For example, the unique identifier can be a code (e.g., numeric, alphanumeric, etc.) printed on the label or a radio frequency identifier (e.g., written to, or otherwise stored on, a radio frequency identification (RFID) tag at printing).

The label 112 is configured to be secured to the item 114 (or packaging for the item 114). For example, the label 112 can include an adhesive, a clip, staples, pins, tacks, etc. with which the customer 110 can secure the label 112 to the item 114. After the customer 110 secures the label 112 to the item 114, and he or she has finished the transaction, he or she can leave the item 114 and leave the retail facility. That is, once the customer 110 has secured the label 112 to the item 114, his or her involvement in the return is complete. For example, the customer 110 can leave the item 114 in a designated area (e.g., a bin, shelf, etc.) or with an employee.

FIG. 1B depicts an employee 116 scanning the item 114 in a self-return system, according to some embodiments. After the customer 110 leaves the item 114, the employee 116 of the retail facility performs functions to allow the return transaction to be finalized. Specifically, the employee 116, via an associate device 118, logs the label 112 that the customer 110 adhered to the item 114. The associate device 118 can be of any suitable type, based on the system. For example, if the unique identifier on the label 112 is an optical code, the associate device 118 includes an optical scanner. As another example, if the unique identifier on the label 112 is encoded in an RFID tag, the associate device 118 includes an RFID reader. Additionally, or alternatively, the associate device 118 can accept user input from the employee 116. For example, the employee 116 may be able to manually enter the unique identifier via a user input device of the associate device 118.

In any event, the logging of the label triggers finalization of the return. When the employee 116 logs the label, an indication of the label (e.g., the unique identifier) and an indication that the item 114 was received is transmitted to a database. The database includes the return transaction for the item. That is, logging of the item 114 indicates that the item was indeed received. Additionally, in some embodiments, the employee 116 can verify that the item 114 is indeed the correct item, that the item 114 is an acceptable condition for return, that the item 114 is complete, etc.

In some embodiments, the employee 116 scans (i.e., logs) returned items periodically throughout the day. For example, the returned items can be collected (e.g., batched) and the employee 116 can scan the items every hour, every few hours, at the end of the day, etc. Because the employee 116 scans the returned items after the customers leave, the customers need not interact with the employee to return the item. Rather, the return is finalized, and a refund provided, after the employee 116 scans the items.

Though the discussion of FIGS. 1A and 1B describe return of an item that is eligible for return, not all items may be returnable at the kiosk 102 (i.e., some items may not be eligible for self-return or returnable generally). In some embodiments, items may not be eligible for self-return based on the item. For example, high value items may not be returnable at the kiosk 102. Additionally, or alternatively, some items may not be eligible for self-return based on the customer 110. As another example, a customer that does not have an established shopping history with the retail facility may not be eligible for self-returns. Whether an item can be returned at the kiosk 102 is based on eligibility rules. The eligibility rules dictate whether a return is permitted at the kiosk 102. The eligibility rules can be based on payment type, category (of the item), subcategory (of the item), amount restrictions (e.g., cost of the item), purchase location (e.g., online vs in-store, in a different jurisdiction, whether the retail facility at which the customer 110 wishes to return the item 114 carries the item 114, etc.), purchase date, current date, non-returnable items, sellability, recalls, transaction identifier format, membership number format, current member status, availability of a receipt, purchase history, return history, etc.

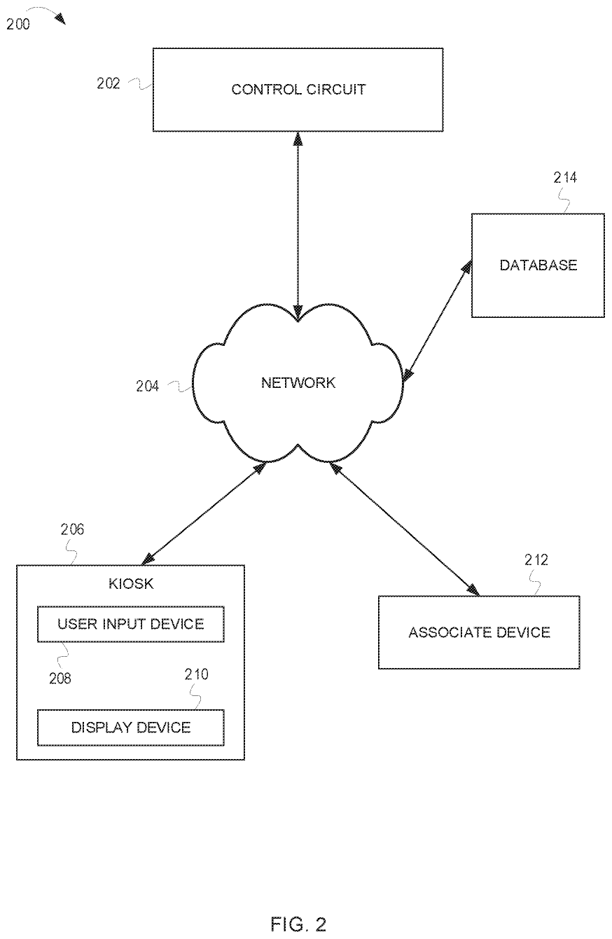

The eligibility rules check can be performed by the kiosk 102 and/or backend systems (discussed in more detail with respect to FIG. 2). In some embodiments, the kiosk 102 can perform initial eligibility checks. For example, the kiosk 102 can determine whether the order identifier is associated with a valid transaction before return eligibility for items included in the transaction is determined. As one example, order identifiers and/or customer identifiers can be used to determine if a transaction is valid. In such embodiments, the retail facility can generate customer identifiers (e.g., membership numbers) and order identifiers based on a formula or hash. In such embodiments, the kiosk 102 can determine whether the information provided is valid locally. If the information is invalid, the kiosk 102 can present a notification to the customer 100 indicating that the return cannot be processed or that the customer 110 needs to proceed to an employee-operated terminal to complete the return.

If the item 114 is not eligible for return at the kiosk 102, the display device 104 can present an indication (e.g., a notification or message) to the customer 110 that the item 114 is not eligible for return at the kiosk 102. The indication can inform the customer 110 that he or she must proceed to, for example, a customer service desk, to complete the return.

While the discussion of FIGS. 1A and 1B provides an overview of self-returns via a kiosk, the discussion of FIG. 2 provides additional detail regarding a system for self-returns.

FIG. 2 is a block diagram of a system 200 for self-returns, according to some embodiments. The system 200 includes a control circuit 202, a kiosk 206, an associate device 212, and a database 214. The control circuit 202, the kiosk 206, the associate device 212, and the database 214 are communicatively coupled via a network 204. Accordingly, the network 204 can be of any suitable type. For example, the network 204 can include a local area network (LAN) and/or wide area network (WAN), such as the internet. The network 204 can include wired and/or wireless links.

The kiosk 206, as discussed with respect to FIG. 1A, allows a customer to conduct self-returns. The kiosk 206 includes a user input device 208. The user input device 208 is configured to receive input from the customer, such as an order identifier, selection of items to return, etc. The user input device 208 can include a physical input and/or a scanner. The physical input can include a mouse, a touchscreen, a keyboard, a trackpad, etc. The scanner can include an optical scanner, an RFID scanner, etc. The customer interacts with the kiosk 206 by providing an order identifier to the kiosk 206 via the user input device 208 (e.g., by entering and/or scanning the order identifier, a customer identifier (e.g., a membership number, email address, phone number), etc.). The kiosk 206 receives transaction information associated with the order identifier and presents, via the display device 210, the transaction information associated with the order identifier. For example, the display device 210 can present the items associated with the transaction, payment information, customer information, etc. Accordingly, the display device 210 can be of any suitable type (e.g., a cathode ray tube (CRT) device, a liquid crystal display (LCD) device, a light emitting diode (LED) device, etc.). The customer selects the item to return from those items presented on the display device 210 via the user input device 208 (e.g., by selecting the item from the list and/or scanning the item).

The control circuit 202 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. The control circuit 202 is configured (for example, by using corresponding programming as will be well understood by those skilled in the art) to carry out one or more of the steps, actions, and/or functions described herein.

By one optional approach the control circuit 202 operably couples to a memory. The memory may be integral to the control circuit 202 or can be physically discrete (in whole or in part) from the control circuit 202 as desired. This memory can also be local with respect to the control circuit 202 (where, for example, both share a common circuit board, chassis, power supply, and/or housing) or can be partially or wholly remote with respect to the control circuit 202 (where, for example, the memory is physically located in another facility, metropolitan area, or even country as compared to the control circuit 202).

This memory can serve, for example, to non-transitorily store the computer instructions that, when executed by the control circuit 202, cause the control circuit 202 to behave as described herein. As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM)).

The control circuit 202 generally processes the return and can be part of a larger set of “backend systems” (e.g., servers, databases, etc.). The control circuit 202 receives the order identifier from the kiosk and retrieves transaction information associated with the order identifier. For example, the control circuit can retrieve the transaction information from a database 214. In such embodiments, the database 214 can store transaction information for customers, as well as customer identifiers. The transaction information includes the items that are associated with order, prices for the items, payment methods, shipping addresses (if any), tax information, purchase location, etc. The control circuit 202 transmits the transition information associated with the order identifier to the kiosk 206 for presentation via the display device 210.

The control circuit 202 receives, from the kiosk 206, selection of the item from the transaction information. For example, the customer can select one item or multiple items that he or she would like to return. The control circuit 202 determines, based on eligibility rules, whether the selected item(s) is eligible for return via the kiosk 206 (i.e., eligible for self-return). Assuming that the selected item(s) is eligible for return via the kiosk 206, the control circuit 202 generates a label for the item(s) and creates, in the database 214, a return transaction for the item. It should be noted that if the customer is returning multiple items, the control circuit 202 can generate multiple return labels (e.g., one for each item being returned) and create multiple return transactions. However, such is not required (i.e., a single label and single return transaction may be used for the return of multiple items). The return label is associated with the return of the item(s). For example, the return label can include a unique identifier. The control circuit 202 transmits the label (e.g., an electronic version of the label) to the kiosk 206 for printing via a printer. The customer secures (e.g., adheres, affixes, etc.) the label to the item to be returned.

After the customer leaves the item, an employee performs actions to complete the transaction. For example, the employee can use the associate device 212 to perform these actions. In one embodiment, the associate device is, or includes, a scanner. In such embodiments, the employee scans the label via the associate device 212. The associate device 212 transmits an indication of the label to the database 214. The indication of the label can implicitly include an indication that the item was received. That is, scanning and transmission of the unique identifier on the label in itself may be the indication of the label and the indication that the item was received. These indications are stored in the database 214. For example, the indication of the label can cause the return transaction in the database 214 to be updated as completed.

When the return transaction is completed in the database, the control circuit 202 finalizes the return. Finalization of the return transaction can include, or prompt, a refund for the customer. That is, once the return transaction is finalized, the customer receives the refund for the item. The customer can receive the refund in the way of a refund of the original payment method (e.g., a credit on his or her credit card), a store credit, a check, etc. Additionally, in some embodiments, the control circuit 202 finalizes the return by calculating a refund. The control circuit 202 can calculate the refund amount based on the purchase price of the item, taxes paid, restocking fees, shipping fees, and any other charges.

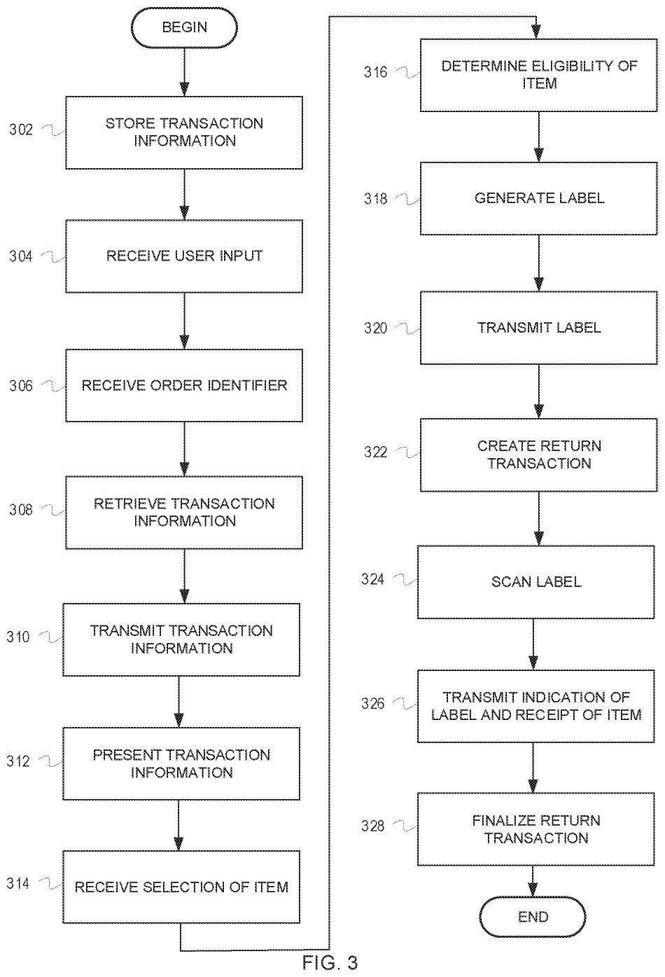

While the discussion of FIG. 2 provides additional detail regarding a system for self-returns by customers, the discussion of FIG. 3 describes example operations of such a system.

FIG. 3 is a flow chart depicting example operations for a self-return system, according to some embodiments. The flow begins at block 302.

At block 302, transaction information is stored. For example, a database can store the transaction information. The transaction information includes information about purchases, returns, and/or exchanges made by customers. The transaction information includes items that were purchased, returned, and/or exchanged in a transaction. Additionally, in some embodiments, the transaction information can include additional information, such as customer identifiers, customer addresses, shipping addresses, purchase locations, purchase dates and/or times, return restrictions, amounts paid, prices of items, taxes paid, etc. The flow continues at block 304.

At block 304, user input is received. For example, the user input can be received via a user input device of a kiosk. The kiosk is a self-return center. For example, the kiosk can include a POS terminal and any additional hardware and/or software required to process returns, purchases, and/or exchanges. The user input includes an order identifier. The order identifier can be of any suitable form, such as a transaction number, a customer identifier, an invoice number, an email address, a phone number, etc. Accordingly, the user input device can be of any suitable type (e.g., a touchscreen, keyboard, touchpad, mouse, scanner, etc.). The flow continues at block 306.

At block 306, the order identifier is received. For example, a control circuit can receive the order identifier from the kiosk. The control circuit receives the order identifier from the kiosk via a network. The flow continues at block 308.

At block 308, transaction information is retrieved. For example, the control circuit can retrieve the transaction information based on the order identifier. The transaction information is associated with the order identifier and includes items that were purchased, returned, and/or exchanged in the transaction. The flow continues at block 310.

At block 310, the transaction information is transmitted. For example, the control circuit can transmit the transaction information to the kiosk for presentation via a display device of the kiosk. The control circuit transmits the transaction information to the kiosk via the network. The flow continues at block 312.

At block 312, the transaction information is presented. For example, the kiosk can present the transaction information to the customer via the display device. The presentation includes a list of items associated with the transaction. For example, the display device can present a list of items purchased, returned, and/or exchanged in that transaction or associated transactions. The flow continues at block 314.

At block 314, selection of an item is received. For example, the kiosk can receive selection of an item via the user input device. The customer selects the item, or items, that he or she would like to return. The customer can select the item, or items, from the list of items and/or scan the item, or items, that he or she would like to return. The flow continues at block 316.

At block 316, eligibility of the item, or items, is determined. For example, the control circuit can determine whether the item is eligible for return generally and/or via the kiosk. The control circuit determines whether the item is eligible for return based on eligibility rules. The return eligibility determination, and thus the eligibility rules, can be as simple or complex as desired. As simple example, the eligibility rules can be temporal. That is, whether an item is returnable can be based on the purchase date, the date of the attempted return, and a return window (e.g., 14 days, 30 days, etc.). As an example of more complex return rules, return eligibility can be based on the value or cost of the item, the customer, the location at which the item was purchased and/or the location at which the customer is attempting to return the item, etc. If the customer has selected multiple items, the control circuit can determine the return eligibility for all of the items selected. It should be noted that it is possible that a customer has selected items that are both eligible and ineligible for return. For example, one of the items selected by the customer may be ineligible for return via the kiosk. In such cases, the control circuit can transmit an indication to the kiosk indicating that one or more of the items is ineligible for return via the kiosk. The kiosk, via the display device, can present a notification to the customer and require the customer to return the ineligible item, or all items, at a location staffed by an employee (e.g., a customer service desk). The flow continues at block 318.

At block 318, a label is generated. For example, the control circuit can generate the label. Assuming that at least one of the items selected by the customer is eligible for return via the kiosk, the control circuit generates a label for that item, or in some embodiments and scenarios, multiple labels. The label is associated with the return of the item. In some embodiments, the label is associated with the return of the item in that it includes a unique identifier. The unique identifier can be of any suitable type, such as a barcode, an RFID tag, an alphanumeric code, etc. The flow continues at block 320.

At block 320, the label is transmitted. For example, the control circuit can transmit the label to the kiosk. In some embodiments, the control circuit transmits an electronic version of the label (e.g., a printer control language file, a .pdf file, etc.). The label is configured to be secured to the item, or packaging containing the item. The customer secures the label to the item, or the packaging containing the item. The flow continues at block 322.

At block 322, a return transaction is created. For example, the control circuit can create the return transaction for the item in the database. The return transaction identifies the item that is being returned and the association with the label. In some embodiments, the return transaction can include additional information. For example, the return transaction can include the customer identifier, a return amount (based on, for example, the purchase price, taxes, fees, etc.), temporal information associated with the return, etc. The flow continues at block 324.

At block 324, the label is scanned. For example, an employee can scan the label via an associate device. After the customer secures the label to the item, or packaging including the item, the customer leaves the item. After the customer leaves the item, the employee scans the label. The employee can scan the label by literally scanning the label (e.g., in embodiments in which the label is scannable) or by entering the label information (e.g., the unique identifier) via the associate device. The employee's scan of the label indicates that the item was received. In some embodiments, the employee can perform additional checks. For example, the employee can examine the item for damage, completeness, correctness, etc. In such embodiments, the employee can include this information in the scan of the item. The flow continues at block 326.

At block 326, an indication of the label and receipt of the item is transmitted. For example, the associate device can transmit the indication of the label and the receipt of the item to the database. The database is updated based on this information. For example, the return transaction in the database can be marked as complete. The flow continues at block 328.

At block 328, the return transaction is finalized. For example, the control circuit can finalize the return transaction based on inclusion of the indication of the label and the receipt of the item in the database. In some embodiments, the control circuit, after finalizing the transaction, provides a refund (e.g., a monetary refund, store credit, etc.) to the customer.

While the discussion of the self-return systems, methods, and apparatuses contained herein refers to self-returns at a kiosk in a retail facility, embodiments are not so limited. For example, in some embodiments, the customer can perform a self-return from home. In such embodiments, the customer can use his or her computing device (e.g., a desktop or laptop computer, tablet, smartphone, etc.) to perform the actions of the kiosk. That is, the customer can enter the order identifier via his or her computing device and select an item to return via his or her computing device. Once the label is generated, the customer can print it at home and secure it to the item, or packaging containing the item. The customer can then return the item in-store (e.g., at a retail facility), mail the item (e.g., from home or at a post office or other mail carrier), or have the item retrieved from his or her home (e.g., via a drone or other autonomous or semiautonomous system). Once the item is received by the retailer (e.g., at a retail facility, distribution center, etc.), an associate can perform the tasks required to finish the return. That is, the associate can scan the label via an associate device.

In some embodiments, a system for self-returns in a retail facility comprises a kiosk, the kiosk comprising a user input device, wherein the user input device is configured to accept input from a user, wherein the user input includes an order identifier, a display device, wherein the display device is configured to present transaction information to the user, wherein the transaction information includes items associated with a transaction, and a printer, wherein the printer is configured to print labels, a control circuit, wherein the control circuit is communicatively coupled to the database and the kiosk, wherein the control circuit is configured to receive, from the kiosk, the order identifier, receive, from the database based on the order identifier, transaction information associated with the order identifier, transmit, to the kiosk for presentation on the display device, the transaction information associated with the order identifier, receive, from the user input device of the kiosk, selection of one or more of the items associated with the transaction, determine, based on eligibility rules, that at least one of the one or more items are eligible for return via the kiosk, generate, for the at least one of the one or more items, a label, wherein the label is associated with a return of the at least one of the one or more items, transmit, to the kiosk for printing, the label, wherein the label is configured to be secured to the at least one of the one or more items, and create, in a the database, a return transaction for the at least one of the one or more items, and an associate device, wherein the associate device is communicatively coupled to the control circuit and the database, the associate device configured to scan, via an associate device scanner, the label, and transmit, to the database, an indication of the label and an indication that the at least one of the one or more items was received, wherein the control circuit is further configured to finalize, based on inclusion of the indication of the label and the indication that the at least one of the one or more items was received, the return transaction for the at least one of the one or more items.

In some embodiments, an apparatus and a corresponding method performed by the apparatus comprises storing, in a database, transaction information, receiving, at a user input device of a kiosk, user input including an order identifier, receiving, at a control circuit from the kiosk, the order identifier, retrieving, from the database based on the order identifier, transaction information associated with the order identifier, transmitting, to the kiosk for presentation on a display device of the kiosk, the transaction information associated with the order identifier, wherein the transaction information includes items associated with a transaction, presenting, by the display device of the kiosk, the transaction information including items associated with the transaction, receiving, at the control circuit from the kiosk via the user input device of the kiosk, selection of one or more of the items associated with the transaction, determining, by the control circuit based on eligibility rules, that at least one of the one or more items are eligible for return via the kiosk, generating, by the control circuit for the at least one of the one or more items, a label, wherein the label is associated with a return of the at least one of the one or more items, transmitting, by the control circuit to the kiosk for printing, the label, wherein the label is configured to be secured to the at least one of the one or more items, creating, by the control circuit in the database, a return transaction for the at least one of the one or more items, scanning, via an associate device scanner of an associate device, the label, transmitting, by the associate device to the database, an indication of the label and an indication that the at least one of the one or more items was received, and finalizing, by the control circuit based on inclusion of the indication of the label and the indication that the at least one of the one or more items was received, the return transaction for the at least one of the one or more items.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A system for self-returns in a retail facility, the system comprising:
a database, wherein the database is configured to store transaction information;
a kiosk, the kiosk comprising:
a user input device, wherein the user input device is configured to accept input from a user, wherein the user input includes an order identifier;
a display device, wherein the display device is configured to present transaction information to the user, wherein the transaction information includes items associated with a transaction; and
a printer, wherein the printer is configured to print labels;
a control circuit, wherein the control circuit is communicatively coupled to the database and the kiosk, wherein the control circuit is configured to:
receive, from the kiosk, the order identifier;
retrieve, from the database based on the order identifier, transaction information associated with the order identifier;
transmit, to the kiosk for presentation on the display device, the transaction information associated with the order identifier;
receive, from the user input device of the kiosk, selection of one or more of the items associated with the transaction;
determine, based on eligibility rules, that at least one of the one or more items are eligible for return via the kiosk;
generate, for the at least one of the one or more items, a label, wherein the label is associated with a return of the at least one of the one or more items;
transmit, to the kiosk for printing, the label, wherein the label is configured to be secured to the at least one of the one or more items; and
create, in the database, a return transaction for the at least one of the one or more items; and
an associate device, wherein the associate device is communicatively coupled to the control circuit and the database, the associate device configured to:
scan, via an associate device scanner, the label; and
transmit, to the database, an indication of the label and an indication that the at least one of the one or more items was received;
wherein the control circuit is further configured to:
finalize, based on inclusion of the indication of the label and the indication that the at least one of the one or more items was received, the return transaction for the at least one of the one or more items.

2. The system of claim 1, wherein finalization of the return transaction includes providing a refund to the user.

3. The system of claim 1, wherein the control circuit is further configured to:
determine, based on the eligibility rules, that a second one of the one or more items is not eligible for return via the kiosk; and
transmit, for presentation via the display device of the kiosk, an indication that the second one of the one or more items is not eligible for return via the kiosk.

4. The system of claim 1, wherein the order identifier includes a customer identifier and transaction identifier, and wherein the kiosk is configured to:
determine, based on one or more of the customer identifier and the transaction identifier, that the transaction information is invalid; and
present, via the display device, an indication that the items associated with the transaction identifier are not eligible for return via the kiosk.

5. The system of claim 1, wherein the user input device includes one or more of a physical input device and a scanner.

6. The system of claim 5, wherein the physical input device includes one or more of a mouse, a touchscreen, a keyboard, and a trackpad, and wherein the scanner includes one or more of an optical scanner and a radio frequency identification (RFID) scanner.

7. The system of claim 1, wherein the transaction identifier is one or more of an identifier associated with a receipt, a membership number, a payment method, and a user identifier.

8. The system of claim 1, wherein the eligibility rules are based on one or more of payment type, category, subcategory, amount restriction, purchase location, purchase date, current date, non-returnable items, sellability, recalls, transaction identifier format, membership number format, current member status, availability of a receipt, purchase history, and return history.

9. The system of claim 1, wherein the selection of one or more of the items associated with the transaction is received via one or more of user selection via the user input device and a scan via the user input device.

10. The system of claim 1, wherein the control circuit finalizes the return transaction by determining a refund amount, wherein the refund amount is based on one or more of a purchase price, tax paid, restocking fees, and charges.

11. A method for self-returns in a retail facility, the method comprising:
storing, in a database, transaction information;
receiving, at a user input device of a kiosk, user input including an order identifier;
receiving, at a control circuit from the kiosk, the order identifier;
retrieving, from the database based on the order identifier, transaction information associated with the order identifier;
transmitting, to the kiosk for presentation on a display device of the kiosk, the transaction information associated with the order identifier, wherein the transaction information includes items associated with a transaction;
presenting, by the display device of the kiosk, the transaction information including items associated with the transaction;
receiving, at the control circuit from the kiosk via the user input device of the kiosk, selection of one or more of the items associated with the transaction;
determining, by the control circuit based on eligibility rules, that at least one of the one or more items are eligible for return via the kiosk;
generating, by the control circuit for the at least one of the one or more items, a label, wherein the label is associated with a return of the at least one of the one or more items;
transmitting, by the control circuit to the kiosk for printing, the label, wherein the label is configured to be secured to the at least one of the one or more items;
creating, by the control circuit in the database, a return transaction for the at least one of the one or more items;
scanning, via an associate device scanner of an associate device, the label;
transmitting, by the associate device to the database, an indication of the label and an indication that the at least one of the one or more items was received; and
finalizing, by the control circuit based on inclusion of the indication of the label and the indication that the at least one of the one or more items was received, the return transaction for the at least one of the one or more items.

12. The method of claim 11, wherein the finalizing the return transaction includes providing a refund to the user.

13. The method of claim 11, further comprising:
determining, by the control circuit based on the eligibility rules, that a second one of the one or more items is not eligible for return via the kiosk; and
transmitting, by the control circuit for presentation via the display device of the kiosk, an indication that the second one of the one or more items is not eligible for return via the kiosk.

14. The method of claim 11, wherein the order identifier includes a customer identifier and a transaction identifier, the method further comprising:
determining, by the kiosk based on one or more of the customer identifier and the transaction identifier, that the order identifier is invalid; and
present, via the display device of the kiosk, an indication that the items associated with the transaction identifier are not eligible for return via the kiosk.

15. The method of claim 11, wherein the user input device includes one or more of a physical input device and a scanner.

16. The method of claim 15, wherein the physical input device includes one or more of a mouse, a touchscreen, a keyboard, and a trackpad, and wherein the scanner includes one or more of an optical scanner and a radio frequency identification (RFID) scanner.

17. The method of claim 11, wherein the transaction identifier is one or more of an identifier associated with a receipt, a customer identifier, a payment method, and a user identifier.

18. The method of claim 11, wherein the eligibility rules are based on one or more of payment type, category, subcategory, amount restriction, purchase location, purchase date, current date, non-returnable items, sellability, recalls, transaction identifier format, membership number format, current member status, availability of a receipt, purchase history, and return history.

19. The method of claim 11, wherein the selection of one or more of the items associated with the transaction is received via one or more of user selection via the user input device and a scan via the user input device.

20. The method of claim 11, wherein the finalizing the return transaction includes determining a refund amount, wherein the refund amount is based on one or more of a purchase price, tax paid, restocking fees, and charges.
